(19) United States
(12) Patent Application Publication
(10) Pub. No.: US 2023/0385376 A1
(43) Pub. Date: Nov. 30, 2023

(54) METHOD FOR DETECTING OUTLIER AND SYSTEM THEREOF

(71) Applicant: SAMSUNG SDS CO., LTD., Seoul (KR)

(72) Inventors: Jae Sun SHIN, Seoul (KR); Joon Yi KIM, Seoul (KR); Min Young LEE, Seoul (KR)

(73) Assignee: SAMSUNG SDS CO., LTD., Seoul (KR)

(21) Appl. No.: 18/204,080

(22) Filed: May 31, 2023

(30) Foreign Application Priority Data
May 31, 2022 (KR) 10-2022-0066785

(51) Int. Cl. G06F 17/18

(52) U.S. Cl. CPC G06F 17/18

(57) ABSTRACT

Provided is a method performed by a computing system for detecting an outlier. The method comprises estimating a first distribution for a given sample set, estimating a second distribution for a target sample, and calculating an outlier score of the target sample for the given sample set based on a difference between the first distribution and the second distribution.

### CROSS-REFERENCE TO RELATED APPLICATION

This application claims priority to Korean Patent Application No. 10-2022-0066785, filed on May 31, 2022, in the Korean Intellectual Property Office, the disclosure of which is incorporated herein by reference in its entirety.

### BACKGROUND

### 1. Field

The present disclosure relates to a method and system for detecting outliers, and more particularly, to a method for calculating outlier scores of given samples and detecting outliers among corresponding samples based on the calculated outlier scores, and a system for performing the method.

### 2. Description of the Related Art

Most of the outlier detection techniques proposed so far detect outliers based on Euclidean distance. In other words, most of the proposed techniques detect outliers using outlier scores based on Euclidean distance. For example, some of the proposed techniques select K samples located around a target sample among a plurality of samples constituting a sample set and calculate an outlier score of the target sample based on the distance between the target sample and the K samples.

However, the above outlier detection techniques have the following two problems.

The first problem is that the accuracy and reliability of outlier detection cannot be guaranteed because the outlier score fluctuates greatly depending on the configuration of the sample set. For example, supposed that, as shown in FIG. 1, two sample sets 11 and 12 are sampled in the sample space for the variable X, and each sample set 11 and 12 is distributed as shown in the lower part of FIG. 1. In this case, since the distance between the target sample 13 and the neighboring samples varies according to the sample sets 11 and 12, the outlier score of the target sample 13 is inevitably different for each sample set 11 and 12.

The second problem is that since the outlier score based on the Euclidean distance does not have an upper bound, it is not possible to accurately determine how high probability the target sample corresponds to the outlier. Euclidean distance-based outlier scores do not have an upper bound because the size of the values can grow infinitely due to their characteristics. Accordingly, it is not possible to accurately determine whether the target sample corresponds to an outlier using only the outlier score values. In addition, there is a problem that it is difficult to compare outlier scores for variables of different distributions.

### SUMMARY

A technical problem to be solved through some embodiments of the present disclosure is to provide a method for accurately detecting an outlier and a system for performing the method.

Another technical problem to be solved through some embodiments of the present disclosure is to provide a method for accurately calculating an outlier score of a target sample for a given sample set and a system for performing the method.

Another technical problem to be solved through some embodiments of the present disclosure is to provide a method for calculating an outlier score bounded to a specified range and a system for performing the method.

Another technical problem to be solved through some embodiments of the present disclosure is to provide a method for calculating an outlier score with high accuracy and reliability regardless of a sample set, and a system for performing the method.

The technical problems of the present disclosure are not limited to the above-mentioned technical problems, and other technical problems not mentioned will be clearly understood by those skilled in the art from the description below.

According to an aspect of the inventive concept, there is provided a method performed by a computing system for detecting an outlier may comprising estimating a first distribution for a given sample set, estimating a second distribution for a target sample and calculating an outlier score of the target sample for the given sample set based on a difference between the first distribution and the second distribution.

In some embodiments, wherein estimating the first distribution may comprises, estimating the first distribution through a kernel density estimation technique.

In some embodiments, wherein estimating the second distribution may comprises, estimating the second distribution using a kernel function defined to have the largest function value at a value of the target sample.

In some embodiments, wherein the outlier score may be calculated based on a relative difference between the first distribution and the second distribution.

In some embodiments, wherein the outlier score may be calculated based on a ratio between a sum value of a first probability function value representing the first distribution and a second probability function value representing the second distribution, and the first probability function value.

In some embodiments, wherein the outlier score may be calculated based on a logarithmic value of the ratio, wherein the logarithmic value may be calculated by a logarithm having as a base a sum of a coefficient of the first probability function value and a coefficient of the second probability function value for the sum value.

In some embodiments, wherein the coefficient of the second probability function value for the sum value may be a setting value of a hyperparameter used to adjust the outlier score.

In some embodiments, wherein the calculated outlier score may be a value with an upper bound.

In some embodiments, wherein the outlier score may be calculated based on Equation 1 below.

$$O {S}_{ε} ( P , z ) := {\int }_{x ∈ χ} P ( x ) \cdot {log}_{( 1 + ε )} ( \frac{( 1 + ε ) \cdot P ( x )}{P ( x ) + ε \cdot {k}_{z} ( x )} ) dx \qquad [ Equation 1 ]$$

Here, OSε denotes the outlier score, P denotes the first distribution, z denotes the target sample, X denotes an entire sample space, P(x) denotes a probability function representing the first distribution, kz(x) denotes a probability function representing the second distribution, and E is a hyperparameter set to a non-zero value.

In some embodiments, wherein the sample set and the target sample may be training sets of a machine learning model, the method further may comprise training the machine learning model using a loss based on the calculated outlier score.

In some embodiments, wherein the outlier score may be calculated based on an amount of information of the second distribution with respect to the first distribution.

In some embodiments, further may comprises, determining the target sample as an outlier in response to determining that the calculated outlier score may be greater than or equal to a reference value.

According to another aspect of the inventive concept, there is provided a system for detecting an outlier may comprising one or more processors and a memory configured to store one or more instructions, wherein the one or more instructions are executable by the one or more processors to perform: estimating a first distribution for a given sample set, estimating a second distribution for a target sample and calculating an outlier score of the target sample for the given sample set based on a difference between the first distribution and the second distribution.

In some embodiments, wherein the outlier score may be calculated based on a relative difference between the first distribution and the second distribution.

In some embodiments, wherein the outlier score may be calculated based on a ratio between a sum value of a first probability function value representing the first distribution and a second probability function value representing the second distribution, and the first probability function value.

In some embodiments, the outlier score may be calculated based on a logarithmic value of the ratio, wherein the logarithmic value may be calculated by a logarithm having as a base a sum of a coefficient of the first probability function value and a coefficient of the second probability function value for the sum value.

In some embodiments, wherein the coefficient of the second probability function value for the sum value may be a setting value of a hyperparameter used to adjust the outlier score.

In some embodiments, wherein the outlier score may be calculated based on an amount of information of the second distribution with respect to the first distribution.

In some embodiments, further may comprises, determining the target sample as an outlier in response to determining that the calculated outlier score may be greater than or equal to a reference value.

According to still another aspect of the inventive concept, there is provided a A non-transitory computer-readable recording medium storing instructions executable by at least one processor to perform: estimating a first distribution for a given sample set; estimating a second distribution for a target sample and calculating an outlier score of the target sample for the given sample set based on a difference between the first distribution and the second distribution.

### BRIEF DESCRIPTION OF THE DRAWINGS

These and/or other aspects will become apparent and more readily appreciated from the following description of the embodiments, taken in conjunction with the accompanying drawings in which:

FIG. 1 is an exemplary diagram for describing problems of an outlier detection method based on Euclidean distance;

FIG. 2 is an exemplary diagram schematically illustrating an outlier detection system according to some embodiments of the present disclosure;

FIG. 3 is an exemplary flowchart illustrating a method for detecting outliers according to some embodiments of the present disclosure;

FIG. 4 is an exemplary diagram for describing a distribution estimation method according to an embodiment of the present disclosure;

FIG. 5 is an exemplary diagram for describing an outlier score-based learning method according to an embodiment of the present disclosure;

FIG. 6 illustrates a distribution of a probability function that can be referenced in various experimental examples of the present disclosure;

FIGS. 7 and 8 show experimental results for the accuracy (or reliability) of outlier scores;

FIGS. 9 and 10 show experimental results on the accuracy (or reliability) of outlier scores according to sample sets;

FIGS. 11 and 12 show experimental results for the variability of outlier scores according to hyperparameters; and

FIG. 13 illustrates an example computing device that may implement an outlier detection system in accordance with some embodiments of the present disclosure;

### DETAILED DESCRIPTION

Hereinafter, example embodiments of the present disclosure will be described in detail with reference to the accompanying drawings. Advantages and features of the present invention, and methods of achieving them will become clear with reference to the detailed description of the following embodiments taken in conjunction with the accompanying drawings. However, the technical idea of the present invention is not limited to the following embodiments and can be implemented in various different forms. Only the following embodiments are provided to complete the technical idea of the present invention, and fully inform those skilled in the art of the technical field to which the present invention belongs the scope of the present invention, and the technical spirit of the present invention is defined by the scope of the claims and their equivalents.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings:

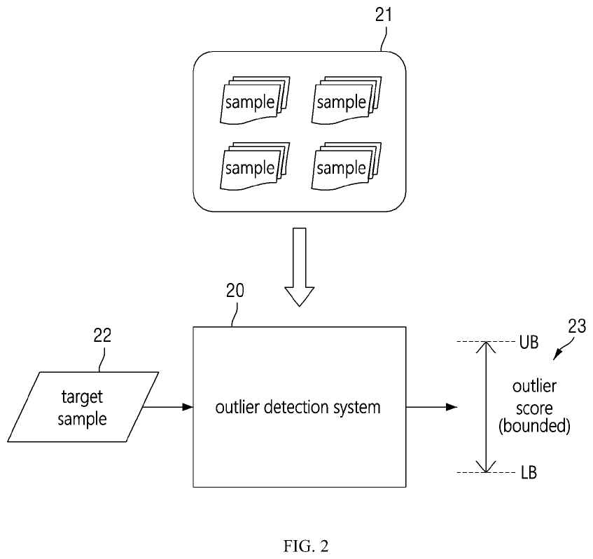

FIG. 2 is an exemplary diagram schematically illustrating an outlier detection system 20 according to some embodiments of the present disclosure.

As shown in FIG. 2, the outlier detection system 20 may be a system that detects (determines) whether a target sample 22 corresponds to an outlier with respect to a given sample set 21. For example, the outlier detection system 20 may calculate an outlier score 23 of the target sample 22 for the sample set 21, and in response to determining that the calculated outlier score is equal to or greater than a reference value, determine the target sample 22 as an outlier.

Here, the sample set 21 is a set of samples following the distribution of a specific variable (or class), and may mean a set of samples that are criteria for determining an outlier. For example, if the outlier detection system 20 is a system for detecting anomaly (or abnormalities), a plurality of normal samples may be used as the sample set 21. The sample set 21 may consist of a plurality of samples corresponding to a part of the entire sample space. Any method of obtaining the sample set 21 may be used.

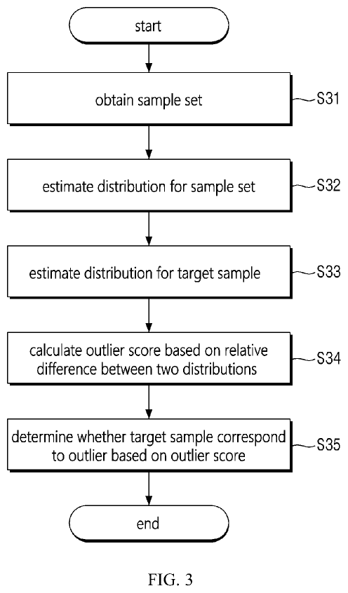

More specifically, the outlier detection system 20 may estimate a first distribution for the sample set 21, estimate a second distribution for the target sample 22, and based on the relative difference between the two distributions, calculate an outlier score 23 of the target sample 22 for the sample set 2. It can be understood that the reason for calculating the outlier score 23 based on the relative difference is to calculate the outlier score 23 as a value with an upper bound (UB) and a lower bound (LB). A detailed method of calculating the outlier score 23 will be described later with reference to FIG. 3 and the following drawings.

The outlier detection system 20 may be implemented with at least one computing device. For example, all functions of the outlier detection system 20 may be implemented in one computing device, or the first function of the outlier detection system 20 may be implemented in the first computing device and the second function may be implemented in the second computing device. Alternatively, specific functions of the outlier detection system 20 may be implemented with a plurality of computing devices.

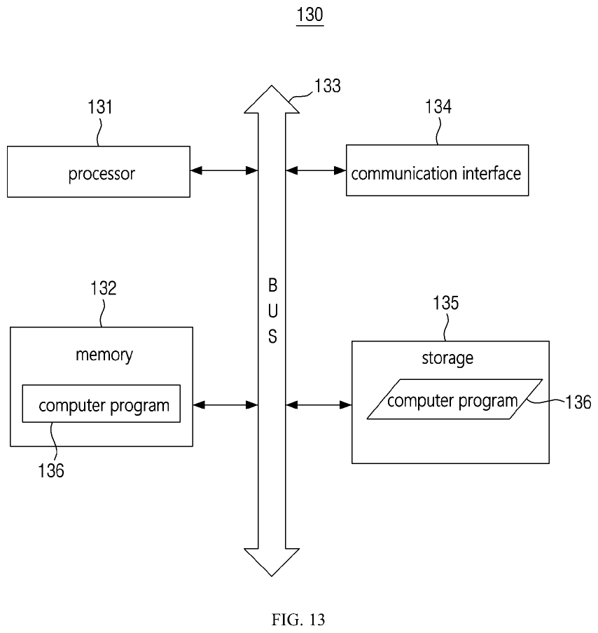

A computing device may encompass any device having a computing function, and an example of such a device can be referred to FIG. 13.

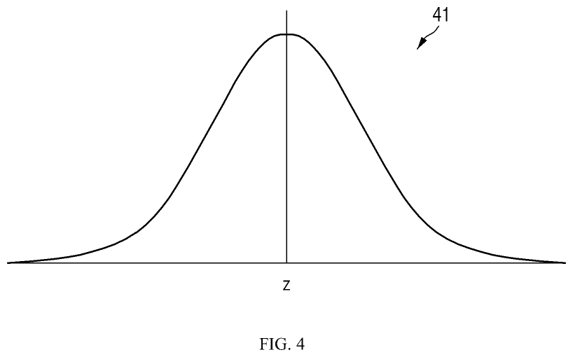

So far, the outlier detection system 20 according to some embodiments of the present disclosure has been schematically described with reference to FIG. 2. Hereinafter, methods that can be performed in the outlier detection system 20 will be described in detail with reference to FIGS. 3 and 4.

Hereinafter, for convenience of understanding, description will be continued on the assumption that all steps/operations of the methods to be described later are performed in the outlier detection system 20. Therefore, when the subject of a specific step/operation is omitted, it can be understood that it is performed in the outlier detection system 20. However, in a real environment, some steps/operations of the methods described below may be performed on other computing devices.

FIG. 3 is an exemplary flowchart illustrating a method for detecting outliers according to some embodiments of the present disclosure. However, this is only an example embodiment for achieving the object of the present disclosure, and some steps may be added or deleted as needed.

As shown in FIG. 3, the method for detecting an outlier according to embodiments may start at step S31 of obtaining a sample set. As described above, the sample set may be composed of a plurality of samples that are criteria for determining an outlier and may be obtained in any method.

In step S32, a distribution for the sample set (hereinafter, referred to as a ‘first distribution’) may be estimated. For example, the outlier detection system 20 may estimate the first distribution (i.e., the probability distribution of the sample set) using a kernel density estimation (KDE) technique. However, the scope of the present disclosure is not limited thereto. Those skilled in the art will already be familiar with the kernel density estimation technique, so a description thereof will be omitted.

In step S33, the distribution for the target sample (hereinafter referred to as ‘second distribution’) may be estimated. For example, the outlier detection system 10 may convert a target sample into a format of distribution using a kernel function for a predetermined distribution (e.g., Gaussian distribution, etc.). Here, it can be understood that the reason for converting the target sample into the format of the distribution is to mathematically calculate a difference between the target sample and the first distribution. In this step, the kernel function may be a function related to any distribution.

In one embodiment, a kernel function defined to have the largest function value at a value of the target sample may be used to estimate the second distribution. In addition, the corresponding kernel function may have a tendency that the function value becomes closer to ‘0’ as the distances from the value of the target sample increases. For example, as shown in FIG. 4, supposed that the kernel function 41 is a function on a Gaussian distribution and ‘z’ is a value of a target sample (e.g., a point of the target sample on a sample space). In this case, the second distribution for the target sample may be estimated using the kernel function 41 defined to represent a Gaussian distribution with an average of ‘z.’ For example, the second distribution of the kernel function 41 can be estimated. By doing so, the target sample can be converted into a distribution that best reflects its characteristics (i.e., the second distribution), and the outlier score of the target sample can be more accurately calculated.

In step S34, an outlier score may be calculated based on the relative difference between the two distributions. For example, the outlier detection system 20 may calculate the outlier score of the target sample based on the ratio between the sum value of the first probability function value representing the first distribution and the second probability function value representing the second distribution, and the first probability function value (e.g., when the probability function representing the first distribution is P(x) and the probability function representing the second distribution is k_{z}(x), the outlier score is calculated based on P(x)/(P(x)+k_{z}(x)) or log(P(x)/(P(x)+k_{z}(x))). Alternatively, the outlier detection system 20 may calculate an outlier score based on the amount of information (e.g., relative entropy) of the second distribution with respect to the first distribution.

As a more specific example, the outlier detection system 20 may calculate an outlier score of a target sample for a sample set according to Equation 1 below. Of course, since the outlier score may be calculated based on various modifications of Equation 1, the scope of the present disclosure is not limited by these examples.

$$O {S}_{ε} ( P , z ) := {\int }_{x ∈ χ} P ( x ) \cdot {log}_{( 1 + ε )} ( \frac{( 1 + ε ) \cdot P ( x )}{P ( x ) + ε \cdot {k}_{z} ( x )} ) dx \qquad [ Equation 1 ]$$

In Equation 1, OS_{ε} denotes an outlier score, P denotes a first distribution, z denotes a target sample, X denotes the entire sample space (or random variable), P(x) denotes a probability function representing the first distribution (e.g., probability density function), k_{z}(x) denotes a probability function representing the second distribution, and ε denotes a hyperparameter set to a non-zero value.

In addition, as described above, k_{z}(x) may be a probability function defined as having the largest function value at ‘z’ and the tendency that the function value gets closer to ‘0’ as the distance from ‘z’ increases.

Hereinafter, in order to provide more convenience of understanding, Equation 1 will be amplified.

Equation 1 is an equation for calculating the outlier score for the target sample (z) based on the relative difference between the first distribution and the second distribution. Conceptually, it can be understood as a formula for calculating an outlier score based on the amount of information (or relative entropy) of the second distribution with respect to the first distribution. Those skilled in the art can readily understand that the log term of Equation 1 represents the amount of information of the second distribution with respect to the first distribution, so a description thereof will be omitted.

In Equation 1, the hyperparameter c can be understood as a value used to adjust the outlier score, and more precisely, as a value used to adjust the severity of outlier determination. For example, as the value of c increases, the outlier score can be calculated relatively higher (i.e., the severity of outlier determination decreases). In this regard, Experimental Example 3 to be described later can be further referred.

In addition, the reason that the base of the logarithm is defined as the sum of the coefficients of P(x) and K_{z}(x) (i.e., ‘1+ε’) and the denominator of the logarithmic term is multiplied by (1+ε) can be understood for adjusting the range of the outlier score between 0 and 1 (but including a boundary value). That is, the outlier score calculated through Equation 1 may have a bounded characteristic. In this regard, further reference will be made to experimental examples to be described later.

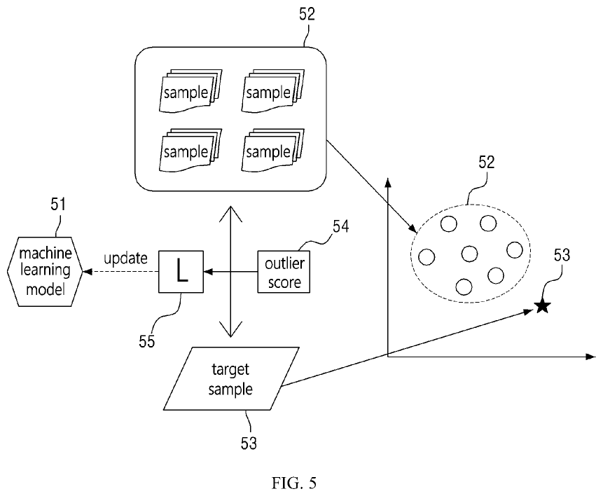

Meanwhile, in an embodiment of the present disclosure, the above-described outlier score may be used as a loss for training a machine learning model. Specifically, by using the fact that an outlier score is a value with upper and lower bounds and a value representing a difference in distribution, the outlier can be used as a loss value of a machine learning model. This embodiment will be further described later with reference to FIG. 5.

It will be described with reference to FIG. 3 again.

In step S35, it may be determined whether the target sample corresponds to an outlier based on the calculated outlier score. For example, the outlier detection system 20 may determine the target sample as an outlier in response to determining that the outlier score is greater than or equal to a reference value. In the opposite case, the outlier detection system 20 may determine that the target sample does not correspond to the outlier. Here, the reference value may be set in any way.

So far, the outlier detection method according to some embodiments of the present disclosure has been described with reference to FIGS. 3 and 4. As described above, a distribution difference between a sample set and a target sample may be mathematically calculated by converting the target sample into a distribution format using a kernel function. In addition, by calculating the outlier score using the distribution difference, the outlier score of the target sample for the sample set can be accurately calculated, and the problem that the accuracy and reliability of the outlier score are lowered due to the variability of the outlier score according to the configuration of the sample set can also be solved (see Experimental Example 2). Accordingly, the accuracy of outlier detection can be greatly improved. Furthermore, by calculating the outlier score of the target sample based on the relative difference in distribution, the outlier score can be calculated as a bounded value, and the probability that the target sample is close to the outlier can be accurately reflected in the calculated score (see Experimental Example 1).

Hereinafter, an outlier score-based learning method according to an embodiment of the present disclosure will be briefly described with reference to FIG. 5.

As shown in FIG. 5, in this embodiment, both the sample set 52 and the target sample 53 may be training sets of the machine learning model 51, and the machine learning model 51 may be a model (e.g., a neural network) that performs a task associated with the training set (e.g., anomaly detection, query answering, class classification, etc.).

In this embodiment, the machine learning model 51 may be trained using the loss 54 based on the outlier score of the target sample 53 for the sample set 52. For example, if the target sample 53 is a sample (e.g. samples of the same class, a positive pair, etc.) having the same or similar characteristics (or distribution) as the sample set 52 (i.e., if it is desired to make the distribution of the target sample 53 to be similar to the distribution of the sample set 52), the outlier detection system 20 may update the weights of the machine learning model 51 in a direction, in which the outlier score decreases. In the opposite case (e.g., samples of different classes, negative pairs, etc.), the weights of the machine learning model 51 may be updated in a direction, in which the outlier score increases.

For a more specific example, suppose that the machine learning model 51 is an anomaly detection model and the sample set 52 is a set of normal samples. In this case, if the target sample 53 is a normal sample, the outlier detection system 20 may update the weight of the machine learning model 51 in a direction, in which the outlier score for the target sample 53 decreases. In the opposite case (i.e., when the target sample 53 is an abnormal sample), the weight of the machine learning model 51 may be updated in a direction, in which the outlier score increases.

As another example, suppose that the machine learning model 51 is a query response model, the sample set 52 is a set of samples for a query or context (e.g., query-related information such as descriptions), and the target sample 53 is a sample related to a response (e.g., response token in context). In this case, the outlier detection system 20 may update the weight of the machine learning model 51 in a direction, in which the outlier score of the target sample 53 with respect to the sample set 52 increases. By doing so, the distributions of query samples and response samples are located separately in the latent space, and ultimately, the query response performance of the machine learning model 51 can be improved.

So far, the outlier score-based learning method according to an embodiment of the present disclosure has been described with reference to FIG. 5. As described above, by using an outlier score having a characteristic bounded to a specified range as a loss value of the machine learning model, the training of the machine learning model can be easily performed.

Hereinafter, the effect of the above-described outlier detection method will be more clearly demonstrated through various experimental examples. Since the embodiments mentioned in the following experimental examples are only some examples of the present disclosure, the scope of the present disclosure is not limited to these embodiments.

The inventors of the present disclosure compared the accuracy (or reliability) of outlier scores through embodiments and comparative examples, and conducted experiments to measure the influence of hyperparameters. In addition, the present inventors assumed the following distribution to generate (sampling) a sample set and a target sample to be used in the experiment. In the following, for brevity of description, when the subject of a sentence is ‘inventors,’ description of the subject is omitted.

Distribution 1

A distribution according to Equation 2 below was assumed. In Equation 2 below, q₋₁(x) and q₁ mean an n-dimensional (provided that n is a natural number greater than or equal to 1) multivariate normal distribution with the averages of −1 and 1, respectively, and λ means the ratio value between 0 and 1 or an identity (unit) covariance matrix multiplied by the ratio value.

p_{λ}(x)=λ·q₋₁(x)+(1−λ)·q₁(x) [Equation 2]

Distribution 2

The same distribution as Distribution 1 was assumed, except that the mean was −λ and the λ value was 10⁻⁴.

Distribution 3

The same distribution as distribution 2 was assumed, except that the mean was 2.

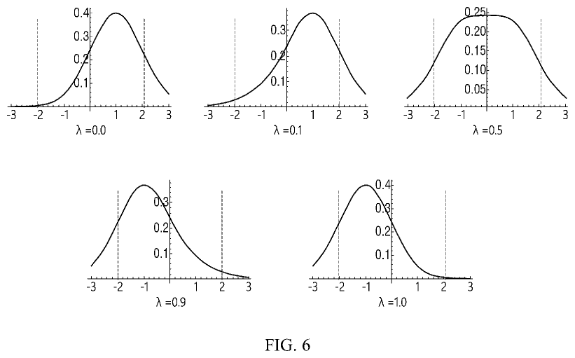

FIG. 6 shows the change of Distribution 1 according to the value of λ. As shown in FIG. 6, it can be seen that, as the value of λ increases, the difference between Distribution 1 and Distribution 2 decreases (e.g., the difference between Distribution 1 and Distribution 2 decreases because the value of p_{λ}(−2) gradually increases), and the difference between Distribution 1 and Distribution 3 increases (e.g., the difference between Distribution 1 and Distribution 3 increases because the value of p_{λ}(2) gradually decreases).

### Embodiment 1

According to the outlier detection method described with reference to FIG. 3, an outlier score of a target sample for a sample set was calculated. More specifically, an outlier score for the target sample was calculated according to Equation 1 above.

### Comparative Example 1

An average Euclidean distance between the target sample and K (where K is set to 5) samples located around the target sample was calculated as an outlier score for the target sample.

### Experimental Example 1: Accuracy (or Reliability) Analysis of Outlier Scores

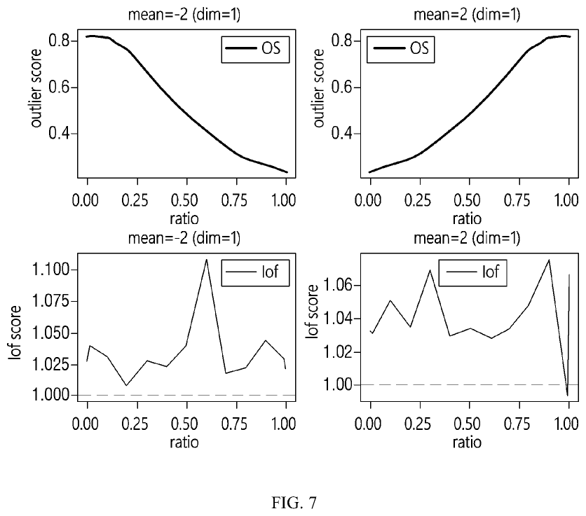

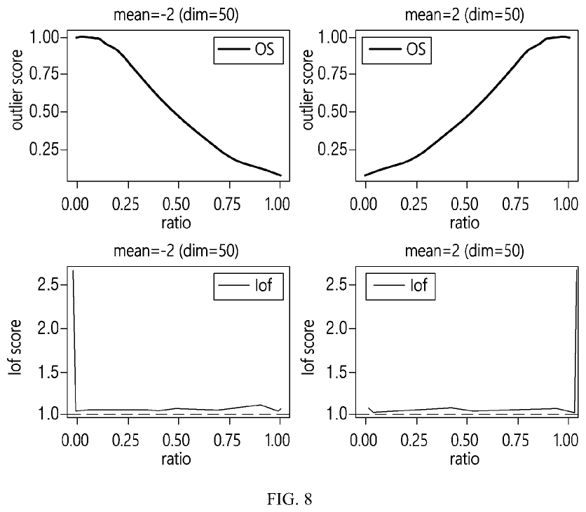

A sample set was configured by extracting (sampling) 20,000 samples from Distribution 1, and 10 target samples were extracted (sampling) from each of Distribution 2 and Distribution 3. And, according to Embodiment 1 and Comparative Example 1, the outlier score of the target sample for the sample set was calculated. The final outlier score was calculated as the average value of outlier scores for 10 target samples, and the experimental results are shown in FIGS. 7 and 8. FIG. 7 shows the experimental results when the dimension of the sample is 1, and FIG. 8 shows the experimental results when the dimension of the sample is ‘50.’ In addition, ‘lof’ or ‘lof score’ in the drawings below FIG. 7 means an outlier score according to Comparative Example 1.

As shown in FIGS. 7 and 8, it can be confirmed that the outlier score according to Embodiment 1 has a value between 0 and 1, and well reflects the probability that the target sample is close to the outlier. For example, it is natural that the probability that the target sample extracted from distribution 2 does not correspond to an outlier increases as the X value increases (because the difference between Distribution 1 and Distribution 2 decreases as the X value increases), and it can be seen that the outlier score according to Embodiment 1 reflects these points well (see the graph on the upper left). In addition, it can be seen that the outlier score according to Embodiment 1 has a very small range of variation, which is considered to be because the outlier score is calculated based on the difference in distribution, to which the sample belongs, rather than the distance between samples.

On the other hand, it can be confirmed that the outlier score according to Comparative Example 1 shows a rapid change in some or all sections, and it can be confirmed that the range of variation of the outlier score increases as the dimension of the sample increases. It is determined that this is because the distance to neighboring samples varies greatly depending on the position of the target sample (i.e., the position in the sample space).

Through this, it can be seen that the outlier score according to Embodiment 1 better reflects the probability that the target sample is close to the outlier compared to Comparative Example 1, and it can be seen that the accuracy and reliability of the outlier score according to Embodiment 1 exceed Comparative Example 1.

### Experimental Example 2: Accuracy (or Reliability) Analysis of Outlier Scores According to Sample Sets

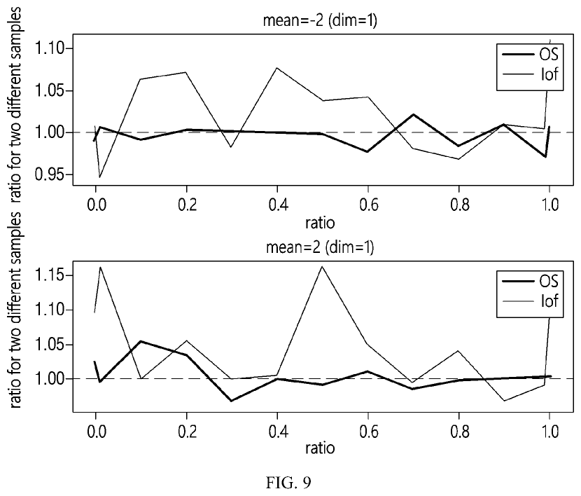

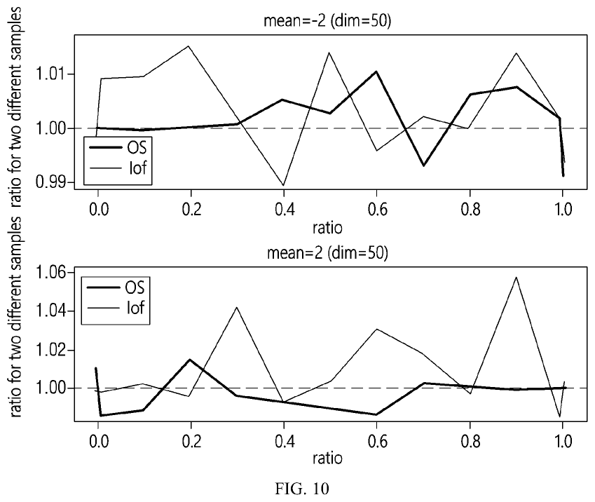

Sample set 1 was configured by extracting 20,000 samples from Distribution 1, and sample set 2 was configured by extracting 20,000 samples again after changing the seed value. In addition, in the same manner as Experimental Example 1, outlier scores of target samples for each sample set were calculated, and the degree of change in the calculated outlier scores was measured. The degree of change in the outlier score was measured by the ratio of the outlier score for sample set 1 and the outlier score for sample set 2, and the experimental results are shown in FIGS. 9 and 10. FIG. 9 shows the experimental results when the dimension of the sample is ‘1,’ and FIG. 10 shows the experimental results when the dimension of the sample is ‘50.’

As shown in FIGS. 9 and 10, it can be seen that the outlier score according to Comparative Example 1 shows a significantly large range of variation as the sample set is changed, and it can be seen that, when the dimension of the sample is high, the range of variation of the outlier score becomes larger. On the other hand, it can be confirmed that the outlier score according to Embodiment 1 shows little change in score according to the sample set. Through this, it can be seen that the outlier score according to Embodiment 1 is robust to changes in the sample set, and that the accuracy and reliability of the outlier score are guaranteed regardless of the configuration of the sample set.

### Experimental Example 3: Variability Analysis of Outlier Scores According to Hyperparameters

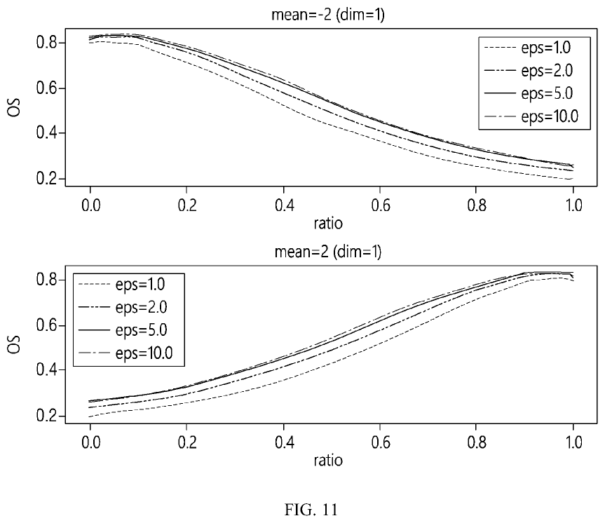

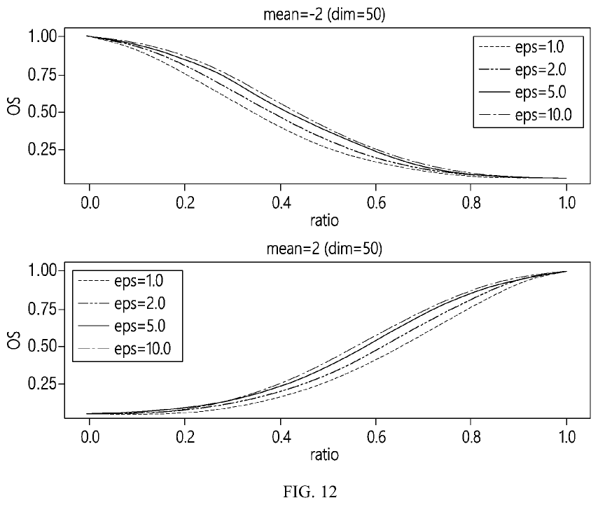

An experiment was conducted to measure the outlier score of the target sample according to Embodiment 1 while changing the value of the hyperparameter (i.e., the set value) from 1 to 10. The outlier score was measured in the same manner as in Experimental Example 1, and the experimental results are shown in FIGS. 11 and 12. FIG. 11 shows the experimental results when the dimension of the sample is ‘1,’ and FIG. 12 shows the experimental results when the dimension of the sample is ‘50.’

As shown in FIGS. 11 and 12, it can be seen that, as the value of the hyperparameter increases, the outlier score is calculated slightly higher, but the tendency of the outlier score is maintained regardless of the hyperparameter value. Through this, in the case of Embodiment 1, it can be seen that the severity of outlier determination is well adjusted by the value of the hyperparameter, and that the accuracy and reliability of the outlier score can be guaranteed at a high level regardless of the value of the hyperparameter.

So far, various experimental examples have been described in order to more clearly demonstrate the effect of the above-described outlier detection method.

Hereinafter, an exemplary computing device 130 capable of implementing the above-described outlier detection system 20 will be described with reference to FIG. 13.

FIG. 13 is an exemplary hardware configuration diagram illustrating computing device 130.

As shown in FIG. 13, the computing device 130 includes one or more processors 131, a bus 133, a communication interface 134, a memory 132 for loading a computer program executed by the processor 131, and a storage 135 for storing the computer program 136. However, only components related to the embodiment of the present disclosure are shown in FIG. 13. Accordingly, those of ordinary skill in the art to which this disclosure belongs may know that other general-purpose components may be further included in addition to the components shown in FIG. 13. That is, the computing device 130 may further include various components other than the components shown in FIG. 13. Also, in some cases, the computing device 130 may be configured in a form, in which some of the components shown in FIG. 13 are omitted. Hereinafter, each component of the computing device 130 will be described.

The processor 131 may control overall operations of each component of the computing device 130. The processor 131 may include at least one of a Central Processing Unit (CPU), a Micro Processor Unit (MPU), a Micro Controller Unit (MCU), a Graphic Processing Unit (GPU), or any type of processor well known in the art. Also, the processor 131 may perform an operation for at least one application or program for executing an operation/method according to embodiments of the present disclosure. The computing device 130 may include one or more processors.

Next, the memory 132 may store various data, commands and/or information. The memory 132 may load computer program 136 from storage 135 to execute operations/methods according to embodiments of the present disclosure. The memory 132 may be implemented as a volatile memory such as RAM, but the technical scope of the present disclosure is not limited thereto.

Next, the bus 133 may provide a communication function between components of the computing device 130. The bus 133 may be implemented as various types of buses such as an address bus, a data bus, and a control bus.

Next, the communication interface 134 may support wired/wireless Internet communication of the computing device 130. Also, the communication interface 134 may support various communication methods other than Internet communication. To this end, the communication interface 134 may include a communication module well known in the art of the present disclosure.

Next, the storage 135 may non-temporarily store one or more computer programs 136. The storage 135 may comprise non-volatile memory such as read only memory (ROM), erasable programmable ROM (EPROM), electrically erasable programmable ROM (EEPROM), flash memory, or the like, a hard disk, a removable disk, or any known type of computer-readable recording medium well known in the art.

In turn, the computer program 136 may include one or more instructions that when loaded into memory 132 cause processor 131 to perform operations/methods in accordance with various embodiments of the present disclosure. That is, the processor 131 may perform operations/methods according to various embodiments of the present disclosure by executing the one or more instructions.

For example, the computer program 136 may include one or more instructions that perform an operation of estimating a first distribution for a given sample set, an operation of estimating a second distribution for a target sample, and an operation of calculating an outlier score for a target sample based on a difference between the first distribution and the second distribution. In this case, the outlier detection system 20 according to some embodiments of the present disclosure may be implemented through the computing device 130.

An exemplary computing device 130 capable of implementing the outlier detection system 20 according to some embodiments of the present disclosure has been described with reference to FIG. 13.

On the other hand, in some embodiments, the outlier detection system 20 may be implemented with at least one virtual machine based on cloud technology. For example, the outlier detection system 20 may be implemented with at least one virtual machine operating on a plurality of physical servers included in a server farm. In this case, at least some of the components of the computing device 130 shown in FIG. 13 may mean virtual hardware.

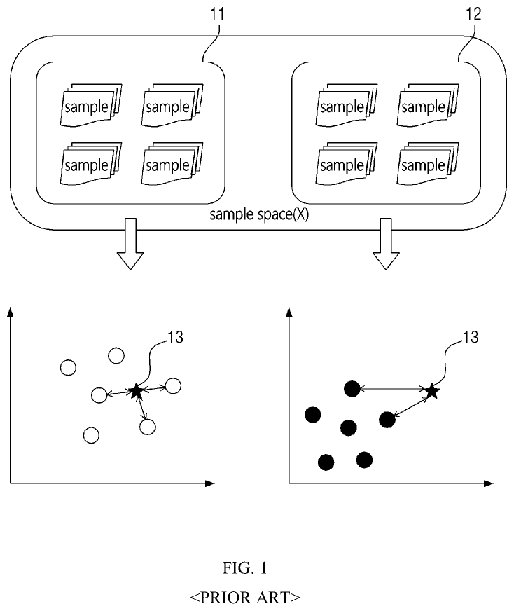

So far, a variety of embodiments of the present disclosure and the effects according to embodiments thereof have been mentioned with reference to FIGS. 1 to 13. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the example embodiments without substantially departing from the principles of the present disclosure. Therefore, the disclosed example embodiments of the disclosure are used in a generic and descriptive sense only and not for purposes of limitation.

What is claimed is:

1. A method performed by a computing system for detecting an outlier, the method comprising:
estimating a first distribution for a given sample set;
estimating a second distribution for a target sample; and
calculating an outlier score of the target sample for the given sample set based on a difference between the first distribution and the second distribution.

2. The method of claim 1, wherein estimating the first distribution comprises,
estimating the first distribution through a kernel density estimation technique.

3. The method of claim 1, wherein estimating the second distribution comprises,
estimating the second distribution using a kernel function defined to have a largest function value at a value of the target sample.

4. The method of claim 1, wherein the outlier score is calculated based on a relative difference between the first distribution and the second distribution.

5. The method of claim 4, wherein the outlier score is calculated based on a ratio between a sum value of a first probability function value representing the first distribution and a second probability function value representing the second distribution, and the first probability function value.

6. The method of claim 5, wherein the outlier score is calculated based on a logarithmic value of the ratio,
wherein the logarithmic value is calculated by a logarithm having as a base a sum of a coefficient of the first probability function value and a coefficient of the second probability function value for the sum value.

7. The method of claim 5, wherein the coefficient of the second probability function value for the sum value is a setting value of a hyperparameter used to adjust the outlier score.

8. The method of claim 4, wherein the calculated outlier score is a value with an upper bound.

9. The method of claim 4, wherein the outlier score is calculated based on Equation 1 below.
$$O {S}_{ε} ( P , z ) := {\int }_{x ∈ χ} P ( x ) \cdot {log}_{( 1 + ε )} ( \frac{( 1 + ε ) \cdot P ( x )}{P ( x ) + ε \cdot {k}_{z} ( x )} ) dx \qquad [ Equation 1 ]$$
Here, OS_{ε} denotes the outlier score, P denotes the first distribution, z denotes the target sample, X denotes an entire sample space, P(x) denotes a probability function representing the first distribution, k_{z}(x) denotes a probability function representing the second distribution, and ε is a hyperparameter set to a non-zero value.

10. The method of claim 4, wherein the given sample set and the target sample are training sets of a machine learning model,
the method further comprise training the machine learning model using a loss based on the calculated outlier score.

11. The method of claim 1, wherein the outlier score is calculated based on an amount of information of the second distribution with respect to the first distribution.

12. The method of claim 1 further comprises,
determining the target sample as an outlier in response to determining that the calculated outlier score is greater than or equal to a reference value.

13. A system for detecting an outlier comprising:
one or more processors; and
a memory configured to store one or more instructions,
wherein the one or more instructions are executable by the one or more processors to perform:
estimating a first distribution for a given sample set;
estimating a second distribution for a target sample; and
calculating an outlier score of the target sample for the given sample set based on a difference between the first distribution and the second distribution.

14. The system of claim 13, wherein the outlier score is calculated based on a relative difference between the first distribution and the second distribution.

15. The system of claim 14, wherein the outlier score is calculated based on a ratio between a sum value of a first probability function value representing the first distribution and a second probability function value representing the second distribution, and the first probability function value.

16. The system of claim 15, the outlier score is calculated based on a logarithmic value of the ratio,
wherein the logarithmic value is calculated by a logarithm having as a base a sum of a coefficient of the first probability function value and a coefficient of the second probability function value for the sum value.

17. The system of claim 15, wherein the coefficient of the second probability function value for the sum value is a setting value of a hyperparameter used to adjust the outlier score.

18. The system of claim 13, wherein the outlier score is calculated based on an amount of information of the second distribution with respect to the first distribution.

19. The system of claim 13, wherein the one or more instructions are executable by the one or more processors to further perform:
determining the target sample as an outlier in response to determining that the calculated outlier score is greater than or equal to a reference value.

20. A non-transitory computer-readable recording medium storing instructions executable by at least one processor to perform:
estimating a first distribution for a given sample set;
estimating a second distribution for a target sample; and
calculating an outlier score of the target sample for the given sample set based on a difference between the first distribution and the second distribution.
